(19) United States
(12) Patent Application Publication
(10) Pub. No.: US 2025/0237076 A1
(43) Pub. Date: Jul. 24, 2025

(54) METHODS AND DISPENSERS FOR RECREATIONAL BODIES OF WATER

(71) Applicant: King Technology, Inc., Minnetonka, MN (US)

(72) Inventors: David Guy, Maple Grove, MN (US); Jeffrey D. Johnson, Edina, MN (US); Brett Libby, Edina, MN (US)

(21) Appl. No.: 19/176,939

(22) Filed: Apr. 11, 2025

Related U.S. Application Data
(63) Continuation-in-part of application No. 18/792,997, filed on Aug. 2, 2024.
Application No. 18/792,997 is a continuation of application No. 17/687,946, filed on Mar. 7, 2022, now Pat. No. 12,054,962.
(60) Provisional application No. 63/207,570, filed on Mar. 8, 2021.

(51) Int. Cl. E04H 4/12; C02F 1/50; C02F 1/52; C02F 103/42

(52) U.S. Cl. CPC E04H 4/1281; E04H 4/1272; C02F 1/50; C02F 1/52; C02F 2103/42

(57) ABSTRACT

A method and dispenser for maintaining a body of water in a swimming pool free of algae with the dispenser water mateable to a surface within a skimmer basket to deliver at least one dispersant to the pool water flowing through the skimmer basket.

### CROSS-REFERENCE TO RELATED APPLICATIONS

This application is a continuation-in-part of U.S. patent application Ser. No. 18/792,997, filed on Aug. 2, 2024, which is a continuation of U.S. patent application Ser. No. 17/687,946, which issued as U.S. Pat. No. 12,054,962 and was filed on Mar. 7, 2022, which claims the benefit of prior filed U.S. Provisional Patent Application No. 63/207,570, filed on Mar. 8, 2021, the contents of each of which are hereby incorporated by reference in their entirety.

### TECHNICAL FIELD

This invention relates generally to recreational bodies of water such as swimming pools and, more specifically, to a basket dispenser where a single or multiple dispersants can be dispensed into the body of water.

### BACKGROUND

One aspect of maintaining a swimming pool is to avoid the growth or outbreak of algae in the pool water, i.e., an algae bloom, which one avoids by adding an algaecide to the pool water. One of the most effective algaecides is copper, which may be combined with a chelating agent to decrease staining.

One of the challenges in using copper as an algaecide (for example, copper sulfate) is to avoid unsightly copper stains on the pool structure since copper stains the pool structure if one allows the copper to remain in contact with the pool structure. Other factors may also cause copper staining including improper water balance, for example the pH of the pool water is too high.

Typically, copper algaecides are available in liquid or granular form, i.e., loose particles or compressed particles, which may or may not be diluted with water. Copper algaecides are also available in metallic form that may be either ionized or non-ionized.

Depending on the form of the copper algaecide there are various methods one may use to minimize or prevent copper staining including preventing the copper in the algaecide from coming into sustained direct contact with the pool structure. For example, one way to minimize copper staining is to dilute the copper algaecide before it is added to the pool water. That is, if the copper algaecide without dilution is added directly to the main body of water the copper algaecide, which is heavier than water, may settle in the bottom of the pool and cause staining on the bottom of the pool.

Typically, in maintaining bodies of recreational water, such as swimming pools, dispersants are controllably delivered into a swimming pool through a dispenser located in an inline dispensing valve, which is located in a pool water circulation system, or through a floating dispenser, which is located in the open body of water in the swimming pool.

Another type of dispenser is an inline dispenser that contains a dispersant in an open sided cage, which is placed in a swimming pool pump basket. The open sided cage delivers a dispersant into a swimming pool pump basket through a set of end and side openings as the open sided cage can tumble about in a swimming pool pump basket.

### SUMMARY

A pool pump basket dispenser metering one or more dispersants with the pool pump basket dispenser having a water mateable surface to support the pool pump basket dispenser in a stable dispensing condition as a dispersant therein is diluted and metered into a stream of pool water as the stream of pool water flows through the pool pump basket.

A water-deformable dispenser for retention in a water circulation system of a swimming pool, the water-deformable dispenser comprising a water porous fabric to allow water to flow into and out of the water-deformable dispenser when the water-deformable dispenser is retained in the water circulation system, and a solid ingredient contained in the water-deformable dispenser, wherein the solid ingredient is a clarifier or flocculant when the solid ingredient is dissolved in water that flows out of the water-deformable dispenser and flows into a body of water of the swimming pool.

A method of preventing or eliminating growth of algae in a swimming pool that comprises a body of water and a water circulation system, the method comprising retaining a water-deformable dispenser in the water circulation system, the water-deformable dispenser comprising a flexible fabric packet and an all-solid clarifier or flocculant, the flexible fabric packet having pores sized to permit ingress and egress of water and to permit a flow of the clarifier or flocculant out of the flexible fabric packet in a dissolved condition, and flowing water into and out of the flexible fabric packet, such that the water contacts the clarifier or flocculant and dissolves the clarifier or flocculant in the water to provide the flow of the clarifier or flocculant out of the flexible fabric packet in the dissolved condition, thereby providing that the clarifier or flocculant is in the dissolved condition before reaching the body of water of the swimming pool.

A water-deformable dispenser for retention in a water circulation system of a swimming pool, the water-deformable dispenser comprising a water porous fabric to allow water to flow into and out of the water-deformable dispenser when the water-deformable dispenser is retained in the water circulation system of the swimming pool, a solid ingredient contained in the water-deformable dispenser, the solid ingredient being in a powder form that is dissolvable in water, and a coating on the water-deformable dispenser that is dissolvable in water.

A method of preventing or eliminating growth of algae in a swimming pool that comprises a body of water and a water circulation system, the method comprising retaining a water-deformable dispenser in the water circulation system, the water-deformable dispenser comprising an all-solid composition, a flexible fabric packet, the flexible fabric packet having pores sized to permit ingress and egress of water and to permit flow of the all-solid composition out of the flexible fabric packet in a dissolved condition, and a coating on the water-deformable dispenser that is dissolvable in water, dissolving the coating in water in the water circulation system, and dissolving the all-solid composition in water flowing into and out of the flexible fabric packet such that the all-solid composition flows out of the flexible fabric in the dissolved condition, thereby providing that the all-solid composition is in the dissolved condition before reaching the body of water of the swimming pool.

### BRIEF DESCRIPTION OF THE DRAWINGS

FIG. 1 shows a typical prior art swimming pool system with a pool pump that circulates water throughout the swimming pool.

FIG. 2 shows a prior art open sided cage that one drops into a pool pump basket.

FIG. 3 shows a deformable pool pump dispenser that is water mateable to an internal structural surface of a pool pump basket.

FIG. 4 shows the deformable pool pump dispenser of FIG. 3 mated to an interior surface of the pool pump basket.

### DETAILED DESCRIPTION

One aspect of maintaining a swimming pool is to avoid the growth or outbreak of algae in the pool water, i.e., an algae bloom, which one can avoid by adding an algaecide to the pool water. One of the most effective algaecides is copper, which may be combined with a chelating agent to decrease staining.

One of the challenges with using copper, as an algaecide, for example copper sulfate, is to avoid unsightly copper stains on the pool structure since copper can stain the pool structure if copper is allowed to remain in contact with the pool structure. Other factors can cause copper staining including improper water balance, for example if the pH of the pool water is too high.

Typically, copper algaecides are available in liquid or granular form, i.e., loose particles or compressed particles, which may or may not be diluted with water. Copper algaecides are also available in metallic form that may be either ionized or non-ionized.

Depending on the form of the copper algaecide there are various methods one may use to minimize or prevent copper staining including preventing the copper in the algaecide from coming into sustained direct contact with the pool structure. For example, one way to minimize copper staining is to dilute the copper algaecide before it is added to the pool water. That is, if the copper algaecide is added directly to the main body of water the copper algaecide, which is heavier than water, may settle in the bottom of the pool and cause staining on the bottom of the pool.

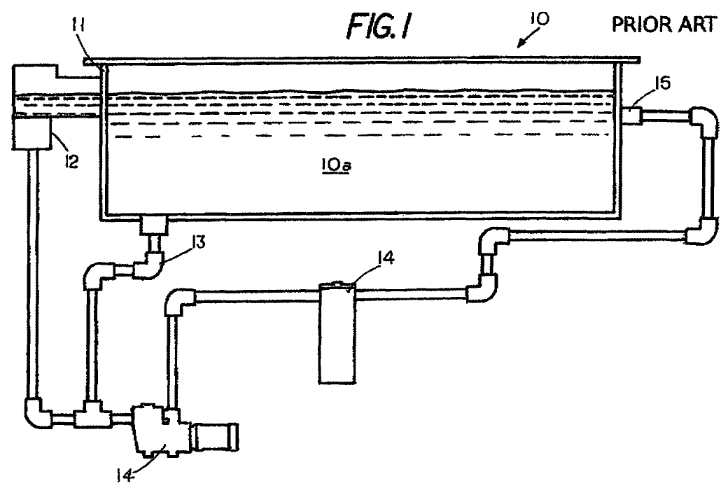

FIG. 1 shows a typical prior art swimming pool 10 with a body of water 10a and a water circulation system, which includes a set of water outlets comprising a skimmer 12 and a drain 13 that directs pool water into a pool pump 14a. Pool pump, which contains a removable pool pump basket, circulates pool water through the pool pump basket and an inline dispensing valve 14a before returning the water to pool 10 through a water inlet 15 located on a side of pool 10.

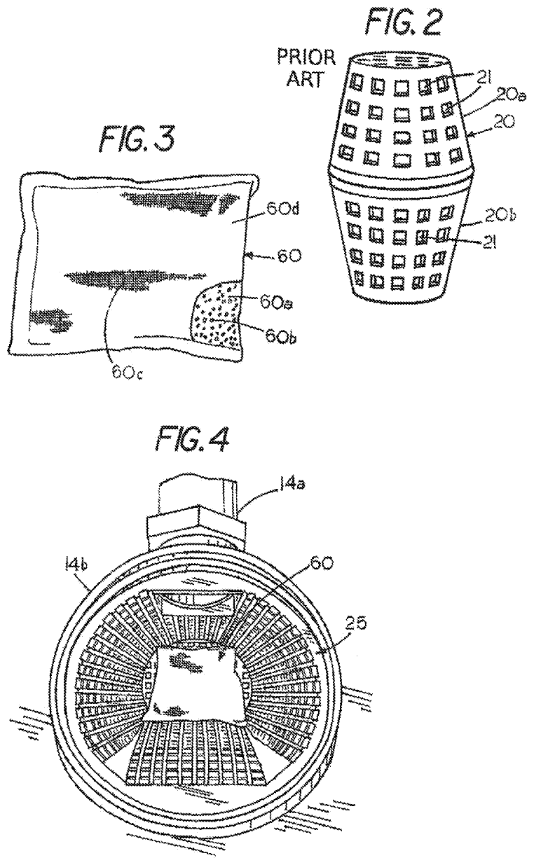

FIG. 2 shows a prior art bulging belly dispensing cage 20 with a circular end of a first truncated hollow conical section 20a joined to a circular end of a second truncated hollow conical section 20b to form a dispersant compartment therein. Rows of rectangular shaped openings 21 in cage 20 allow a dispersant therein to escape from within the bulging belly dispensing cage 20. After the belly bulged dispensing cage 20 has been dropped into a pool the cage 20 can tumble about in the pool pump basket as the contents in the cage are released into the water in the pool pump basket.

In one embodiment of the invention the mateable pool pump basket dispenser 60 comprises a flexible fabric water porous immersible algaecide packet 60d that is held in a stable dispensing condition as water flows through the pool pump basket and the algaecide packet 60d.

In another example, the algaecide packet 60d comprises a woven mesh bag, for example, a spun fiber mesh bag that allows water to flow into and out of the pores or openings in the algaecide packet when the algaecide packet is located in a pump basket of a swimming pool system. The algaecide packet 60d may take various forms and may include a coating on the outside of the packet comprising a dissolvable material (PVA or the like) to retain the contents within the algaecide packet during shipping and handling of the algaecide packet as well as prior to placing the algaecide packet into a pump basket in a swimming pool circulation system.

In the present invention, the dilution of the algaecide in the water porous packet 60d (FIG. 3) becomes controllable by selecting the appropriate water porosity of the packet. That is, the pores or openings in the packet limit or meter water into and out of the packet since the size of the pores as well as the boundary layer proximate the pores provide a flow resistance usable to control the velocity of water into and out of the packet and consequently the rate of the algaecide dispersant into the pool pump basket. The flow resistance of pool pump water through packet 60d provides a further benefit since the flexible packet 60d can be water mateably held in a dispensing condition against a set of openings in a pool pump basket during flow of water through the pool pump basket 25.

Examples of algaecides 60b, such as copper metallic material, which are located within the algaecide packet 60d may take various forms including sheets, foil, shot, wire, or ribbon. Alternately, one may impregnate the algaecides 60b directly into the mesh of the algaecide packet 60d.

Location for the algaecide packet is preferably in the pool pump basket 14 of a swimming pool 10, however, in some instances the skimmer basket or leaf catcher basket may be used. In addition, one may install the algaecide packet in a custom built in-line housing, for example, an in-line housing that attaches to a fitting on a return side of the swimming pool water circulation system.

The algaecide packet 60d may contain a float for easy and quick removal of a spent algaecide packet from within the pool circulation system.

While a mesh algaecide packet 60d is described other types of water-mateable packets made from materials such as a flexible or water deformable materials may be used. That is, the packet material needs to permit water to simultaneously flow around and through packet 60d to contact the algaecide therein when the packet 60d is water-mated to a surface of pool pump basket 25 through a flow water though the pool pump basket 25.

To retain the algaecide packet 60d, which is flexible, within the pool circulation system a clip or connector may be used to temporarily secure the algaecide packet to structure within the pool circulation system as water continues to flow through the algaecide pocket.

A further example of an algaecide packet 60d is a coated packet, i.e., a dissolvable Poly Vinyl Alcohol (PVA) material located on the exterior of the packet 60d to retain the contents of the algaecide packet during shipping and handling.

Examples of the types of other copper metallic material, which are usable within a pool pump dispenser such as algaecide packet 60d, include copper in a variety of forms, for example, copper in sheet, foil, shot, wire or ribbon form.

In some cases, the locations for the algaecide packet may be in locations other than the pump basket such as a skimmer basket, a leaf catcher basket, a purpose-built algaecide cartridge in-line housing or a purpose built housing that attaches to one of the return fittings on the pool circulation system.

In the example of the algaecide packet 60d described herein, the algaecide packet may contain an algaecide and a cocktail of chelators located therein to allow pool water flow into and out of the algaecide packet as the algaecide packet is restrained within a pool pump basket, i.e., water mated within a pump basket in a swimming pool circulation system caused by a combination of the flexibility of the packet and the forces on the packet generated from the flow of water through a pool pump basket and the packet within the pool pump basket.

One example of an algaecide packet 60b to destroy algae and limit copper staining in a swimming pool includes copper sulfate pentahydrate and a zinc sulfate monohydrate plus a cocktail of at least two chelators wherein the chelators are selected from the group consisting of zinc sulfate, ethylenediamine tetraacetic acid (EDTA), sodium gluconate, triethanolamine hydrochloride and citric acid.

Another example of an algaecide packet with a cocktail of chelators suitable to destroy algae and limit copper staining comprises an algaecide packet that contains 50% Copper Sulfate Pentahydrate by weight and 10% Zinc Sulfate by weight, where the cocktail of chelators comprises 10% ethylenediamine tetraacetic acid (EDTA) by weight, 10% Sodium Gluconate by weight, 10% Triethanolamine Hydrochloride by weight, and 10% Citric Acid by weight.

Other features of the algaecide packet 60d described herein may include a float within the algaecide packet for easy removal of a spent algaecide packet from a pool circulation system.

The algaecide packet 60d described herein may include a clip that allows the algaecide packet to be retained within other parts of the system, for example by attaching the algaecide packet to the skimmer basket handle or a lip of a pump basket.

A benefit of the algaecide packet described herein is that when the packet is placed in a pump basket, the packet delivers or meters a slow release of a chelated copper-based algaecide that is mixed with and diluted by the pool water in the pump basket. Consequently, by the time the water diluted algaecide reaches the main area of the pool, the chances of staining the pool are substantially diminished or eliminated. A feature of the invention is that the porosity of the packet may be used to control or limit the velocity or the amount of water that flows through the algaecide packet and hence a dispersant rate of a copper containing algaecide.

In one example of the invention described herein, the algaecide packet hinders and prevents copper staining by addition of a source of copper ions and cocktail of chelators where all of the active contents of the algaecide packet are in powder form.

The all-solid powder ingredients in algaecide packet may include solid triethanolamine hydrochloride instead of the more commonly used liquid triethanolamine. The all-solid or powder ingredients provide a cost-effective manufacturing process since the solid triethanolamine hydrochloride eliminates the steps of dissolving and drying the ingredients of the contents of the algaecide packet.

A further benefit of the algaecide packet described herein is that one can include a mineral based sanitizer in conjunction with an algaecide packet to simultaneously provide the benefits of both a sanitization agent and algaecide, which may be in a single dispenser.

FIG. 4 shows a pool pump water-mateable dispenser 60, i.e., a water deformable algaecide dispenser 60, which may be a porous fabric, which comprises a water porous immersible algaecide packet 60d containing a copper based algaecide 60b and a cocktail of chelators 60a with the algaecide packet 60d placeable in a water mating condition in a swimming pool pump basket to mix copper ions from a copper based algaecide 60b and the chelators 60a into the water flowing though the pool pump basket 25 to minimize staining of the pool structure as the pump circulates pool water through the swimming pool water circulation system as shown in FIG. 1.

FIG. 4 shows the pool pump water-mateable dispenser 60 in a water-mated condition at a bottom of the swimming pool pump basket 25. The water-mateable dispenser 60 is held in position through water pressure created by the resistance to water flowing through the fabric or material of the dispenser 60 and the dispersants 60a and 60b located in dispenser 60. That is, a particle and fabric resistance of the water-mateable dispenser 60. In this example the dispenser 60, which includes dispersants such as an algaecide 60b that includes a source of copper ions and a cocktail of chelating agents 60a, forms a water porous packet 60d that is placeable within a swimming pool water circulation system to deliver copper ions throughout the swimming pool while minimizing or preventing copper ions in the algaecide from staining the pool structure.

In another example, one may minimize copper staining by diluting the copper based algaecide and slowly metering the copper based algaecide into the pool water at a location upstream of a water pump impellor on the pool circulation system thereby mixing copper algaecide with the pool water and thus diluting the copper algaecide before it flows through the external structure of the pool recirculation system. While mixing and diluting the algaecide 60b can ideally be performed by placing water-mateable dispenser 60 in a pool pump basket of the swimming pool, the dispenser 60 is not limited to placement in the pool pump basket as long as water can flow through packet 60d.

In the example shown, the water-mateable dispenser 60 may contain a copper based algaecide and a cocktail of chelators thereby forming an algaecide packet 60d placeable directly in a swimming pool pump basket 25 to mix copper ions from the copper based algaecide and the chelators 60b into the pool water to minimize staining of the pool structure as the pool pump 14 circulates pool water through the swimming pool water circulation system and the water-mateable dispenser 60, which is located in the swimming pool pump basket. The algaecide 60b including a source of copper ions and a cocktail of chelating agents 60a that are contained in a flexible water-mateable dispenser 60 namely, a flexible water-mateable porous packet 60d placeable within a pool pump basket 25. The suction from the pool pump 14 holding water-mateable dispenser 60 in a stable water-mateable contact with a portion of the porous pool pump basket 61 to avoid uneven dispensing due to tumbling of the water-mateable dispenser 60 in the pool pump basket.

During operation, pump 14 of the pool water circulation system (as shown in FIG. 1) delivers copper ions throughout the swimming pool while minimizing or preventing the copper ions in the algaecide from staining the pool structure by in situ diluting the copper based algaecide within the algaecide packet 60d and slowly metering the diluted copper based algaecide into the pool water through the porous sides of water-mateable dispenser 60, which is at a location upstream of a water pump impellor on a pool circulation system. Thus, the invention described herein enables one to mix and dilute the copper algaecide with the pool water before the copper algaecide flows through the external structure of the pool recirculation system and into the swimming pool thereby minimizing or eliminating staining of the pool structure.

In the example shown in FIG. 3 and FIG. 4, the pool pump water-mateable basket dispenser 60 comprises a packet 60d having a water porous flexible fabric 60c forming a compartment therein that contains an algaecide 60b and chelators 60a that are confined within the compartment formed by the water porous flexible fabric 60c. In this example the water-mateable dispenser 60 (i.e., packet 60d) is placeable in a dispensing condition within a pool pump basket with the water porous flexible packet 60d having sufficient porosity and flexibility to allow water to be drawn through the flexible fabric 60c and the algaecide 60b therein as a stream of water is sucked though the pool pump basket 25 by a pump located downstream of the pool pump basket 25.

In this example, the porosity of the fabric 60c and the velocity of the water through the pool pump basket 25 can be adjusted to ensure that the algaecide therein is properly mixed. Thus, selecting the appropriate water porosity of fabric 60c can be used to control the dispensing rate when water mateable dispenser 60 is held in a water mateable condition in a pool pump basket. That is, the pores or openings in the packet fabric 60c function to meter water into and out of the packet 60d during water flow therethrough since the size of the pores as well as the boundary layer proximate the pores or openings in fabric 60c provide a flow resistance that can be used to control the velocity of water into and out of packet 60d and consequently the rate of the algaecide dispensed into pool pump basket 25.

An example of an algaecide for use in water-mateable dispenser 60 is a dry copper algaecide 60b. In this example, water-mateable dispenser 60 comprises a rectangular packet 60d that is supportable in a water-mated dispensing condition in a pool pump basket through water pressure that deforms the packet 60d to maintain the packet in stable dispensing condition. That is, a flow deformation of the packet 60d causes the packet 60d to remain in a stable dispensing condition through an interlocking engagement of flexible fabric 60c of packet 60d with a web structure of the pool pump basket.

Preferably, at least a portion of the flexible fabric 60c of water-mateable dispenser 60 has pores or openings sufficiently large therein for ingress and egress of water through the fabric 60c of packet 60d to thereby disseminate algaecide 60b in a diluted condition into a stream of water flowing through the pool pump basket while also preventing undiluted algaecide in packet 60d from flowing out of the water-mateable dispenser 60.

In another example, water-mateable dispenser 60, which comprises an algaecide packet 60d, may be a woven mesh bag with an algaecide therein, for example, a spun fiber mesh bag that allows water to flow into and out of the pores or openings in the algaecide packet 60d when the algaecide packet is located in a swimming pool system. The water-mateable dispenser 60 may take various other forms and may include a coating on the outside of an algaecide packet 60d where the coating comprises a dissolvable material (PVA or the like) to retain the contents within the algaecide packet 60d during shipping and handling of the algaecide packet as well as prior to placing the algaecide packet into a pool pump basket in a swimming pool circulation system.

Examples of algaecides such as copper metallic material located within the algaecide packet 60d may take various forms including sheets, foil, shot, wire, or ribbon. Alternately, one may impregnate the algaecide directly into the mesh of the algaecide packet 60d.

As described herein, the location for the algaecide packet 60d is preferably the pool pump basket of a swimming pool, however, the skimmer basket or leaf catcher basket may be used in certain pool systems. In addition, one may install the algaecide packet 60d in a custom built in-line housing, for example, an in-line housing that attaches to a fitting on a return side of the swimming pool water circulation system.

The algaecide packet 60d may contain a float for easy and quick removal of a spent algaecide packet from within the pool circulation system.

While a mesh flexible algaecide packet 60d is described, other types of algaecide packets may include, for example, a polymer plastic housing to permit water to flow around and through openings in the housing to contact the algaecide therein.

To retain the algaecide packet 60d within the pool circulation system, a clip or connector may be used to temporarily secure the algaecide packet to structure within the pool circulation system.

A further example of an algaecide packet 60d is a coated packet, i.e., a dissolvable (polyvinyl acetate) or other material, which is located on an exterior face of the algaecide packet 60d to retain the powder contents of the algaecide packet during shipping and handling.

Examples of the type of copper metallic material usable within an algaecide cartridge or algaecide packet 60d includes copper in a variety of forms including copper in sheet, foil, shot, wire or ribbon form.

In some cases, the locations for the algaecide packet 60d may be in locations other than the pump basket such as a skimmer basket, a leaf catcher basket, a purpose-built algaecide cartridge in-line housing or a purpose built housing that attaches to one of the return fittings on the pool water circulation system.

In the example of the algaecide packet 60d described herein, the algaecide packet preferably contains an algaecide and a cocktail of chelators located therein to allow pool water flow into and out of the algaecide packet as the algaecide packet is typically restrained within a pump basket in a swimming pool circulation system through the water mateable feature of dispenser 60.

In one example, an algaecide packet 60d, which can be used to destroy algae and limit copper staining in a swimming pool, includes copper sulfate pentahydrate and zinc sulfate monohydrate and a cocktail of at least two chelators wherein the chelators are selected from the group consisting of, ethylenediamine tetraacetic acid (EDTA), sodium gluconate, triethanolamine hydrochloride and citric acid.

An example of an algaecide packet 60d with a cocktail of chelators suitable to destroy algae and limit copper staining comprises an algaecide packet that contains 50% Copper Sulfate Pentahydrate by weight where the cocktail of chelators comprises 10% Zinc Sulfate by weight, 10% ethylenediamine tetraacetic acid (EDTA) by weight, 10% Sodium Gluconate by weight, 10% Triethanolamine Hydrochloride by weight, and 10% Citric Acid by weight.

Other features of the algaecide packet 60d may include a float within the algaecide packet for easy removal of a spent algaecide packet from the pool circulation system.

Still other features of the algaecide packet 60d described herein may include a clip to restrain the algaecide packet by attaching the algaecide packet 60d in a water mateable condition on a skimmer basket handle or a lip of a pool pump basket.

A benefit of the water mateable algaecide packet 60d described herein, which is placed in a pump basket, is that the algaecide packet 60d delivers a slow release of a chelated copper-based algaecide that is mixed and diluted by the pool water in the pump basket so that when the diluted algaecide reaches the main area of the pool, the chances of staining the pool are prevented or substantially diminished.

In one example, the algaecide packet 60d hinders and prevents copper staining via addition of a source of copper ions and a cocktail of chelators in the algaecide where all of the active contents of the algaecide packet are in powder form.

All-solid powder ingredients in algaecide packet 60d may include solid triethanolamine hydrochloride instead of the more commonly used liquid triethanolamine. The all-solid or powder ingredients provide a cost-effective manufacturing process since the solid triethanolamine hydrochloride eliminates the steps of dissolving and drying the ingredients of the contents of the algaecide packet 60d.

A further benefit of the algaecide packet 60d described herein is that one can include a mineral based sanitizer in conjunction with an algaecide packet to simultaneously provide the benefits of both a sanitization agent and an algaecide, which may be in a single dispenser.

Thus, in a swimming pool dispensing system, one can including an algaecide located within a packet 60d containing a copper algaecide, wherein the packet 60d resides in a pump basket of a water circulation system of a swimming pool.

In some examples, packet 60d can contain an algaecide/clarifier/flocculent composition that is all-solid powder that can be compressed into either a pellet or a tablet for insertion into a pool pump basket.

In other examples, packet 60d can be part of an algaecide/clarifier/flocculent delivery method that consists of adding a first liquid chelator to a swimming pool and a powder algaecide to a pump basket or adding a first liquid chelator to a swimming pool and a powder algaecide to a skimmer basket. Alternately, a combination algaecide/clarifier/flocculent product can be formed consisting of both a copper algaecide and a silver sanitizer as a single mixed all-solid product.

A further feature of the flexible deformable packet 60d is that one can control pump flow rate to control the amount or rate of dispensing the algaecide into the pool thereby allowing one to use a variety of algaecides since the water mateable packet can maintain its dispensing position as the water flow therethrough is increased or decreased.

Thus, within the scope of this disclosure is a water-deformable dispenser having a solid ingredient retained therein. The water-deformable dispenser may retain a solid ingredient therein such that water flowing into and out (e.g., into, through and out of) of the water-deformable dispenser dissolves the solid ingredient and allows the solid ingredient to flow out of the water-deformable dispenser in a dissolved condition. For example, the dissolved solid ingredient may flow from the water-deformable dispenser (and through at least part of the water circulation system) to a body of water 10a of the swimming pool.

In one or more embodiments, the solid ingredient comprises a clarifier or flocculant composition. Clarifiers and flocculants are compositions that may be used to improve the clarity of water by removing one or more contaminants and/or compounds from the water. Clarifiers and flocculants may work by clumping and/or bonding to a compound or contaminant, so the compound or contaminant can be removed from a body of water. For example, removal may be conducted by filtering or vacuuming the compound or contaminant out of the water.

In one or more embodiments, the clarifier or flocculant is a phosphate removal agent configured to remove phosphate from the body of water of the swimming pool. Limiting the amount of phosphate in a swimming pool limits algae growth, as phosphate is a key nutrient for algae. In a preferred embodiment, the phosphate removal agent comprises (e.g., is) aluminum sulfate, lanthanum chloride, or both.

A clarifier or flocculant composition may include aluminum sulfate (i.e., “Alum”), lanthanum chloride, polymers such as polymeric quaternary ammonium compounds, copper-based compounds, polymeric flocculants such as polyacrylamide, chitosan, hydrogen peroxide, chlorine-based compounds, enzymes, citric acid, sodium carbonate, tannin-based compounds, silica gel, and combinations thereof. Thus, in certain embodiments, the solid ingredient comprises any one or more of these materials, e.g., any two or more (such as both aluminum sulfate and lanthanum chloride), or any combination of three or more of these materials. In some cases, the solid ingredient consists (or consists essentially) of aluminum sulfate, lanthanum chloride, or both.

In one or more embodiments, the solid ingredient comprises a stain and scale treatment, a chelator, or both. Conventional stain and scale treatment compounds and/or compositions are adapted to prevent or remove mineral deposits and metal stains. Examples of chelators or stain and scale treatment compounds and/or compositions may include ethylenediamine tetraacetic acid (EDTA), sodium gluconate, triethanolamine hydrochloride, 1-hydroxyethylidene-1,1-diphosphonic acid (HEDP), citric acid, polyphosphates, ascorbic acid, oxalic acid, phosphonic acid, copper sulfate, sodium carbonate, zinc compounds such as zinc sulfate, sodium hexametaphosphate, surfactants, and combinations thereof. In some cases, the solid ingredient consists (or consists essentially) of one or more of the chelators or stain and scale treatment compounds and/or compositions noted in this paragraph. In certain embodiments, the solid ingredient comprises (or consists of, or consists essentially of): (i) aluminum sulfate and/or lanthanum chloride, in combination with (ii) any one or more of the chelators or stain and scale treatment compounds and/or compositions noted in this paragraph.

In one or more preferred embodiments, the solid ingredient comprises aluminum sulfate, lanthanum chloride, or both. The water-deformable dispenser can optionally further comprise an algaecide, such as a copper-containing algaecide. Alternatively, the water-deformable dispenser may be devoid of an algaecide or at least devoid of a copper-containing algaecide.

In embodiments where aluminum sulfate is used, the amount of aluminum sulfate may be in a range from 1 to 15 ounces per 10,000 gallons of water. It will be appreciated that many different recreational bodies of waters of various sizes can be used, and the noted ratio range can optionally be used. As one non-limiting example, for a plunge pool or endless pool having 1,000 gallons of water, the amount of aluminum sulfate provided in the water-deformable dispenser may be in a range from 0.1 to 1.5 ounces. In preferred embodiments, the amount of aluminum sulfate is in a range from 5 to 10 ounces per 10,000 gallons of water. As one non-limiting example, the amount of aluminum sulfate is about 8 ounces per 10,000 gallons of water. In some cases, for a pool having 20,000 gallons of water, the amount of aluminum sulfate provided in the water-deformable dispenser may be in a range from 2 to 30 ounces, such as about 16 ounces.

In embodiments where lanthanum chloride is used, the amount of lanthanum chloride may be in a range from 1 to 15 ounces per 10,000 gallons of water. In a preferred embodiment, the amount of lanthanum chloride in the water-deformable dispenser is in a range from 3 to 9 ounces per 10,000 gallons of water in the body of water (e.g., swimming pool). In certain examples, the amount of lanthanum chloride is about 6 ounces per 10,000 gallons of water.

When both lanthanum chloride and aluminum sulfate are provided in a water-deformable dispenser, the individual amounts of lanthanum chloride and aluminum sulfate may be reduced. In some cases, there is more lanthanum chloride than aluminum sulfate (e.g., at least 50% more (e.g., by weight), at least 100% more, or even at least twice as much). This, however, is by no means required. In one non-limiting example including both aluminum sulfate and lanthanum chloride, the amount of aluminum sulfate is about 2 ounces and the amount of lanthanum chloride is about 4 ounces (per 10,000 gallons of water).

In other embodiments, the solid ingredient comprises copper and chelator(s), and these materials are present in a range of 2 to 10 ounces per 10,000 gallons of water. For example, in certain embodiments of this nature, the amount of copper and chelator(s) may be 4 to 7 ounces per 10,000 gallons of water. In embodiments of this nature, the ratio of copper and chelator(s) can optionally be about 1:1. In one non-limiting example, a mixture of copper and chelator(s) is 52.8% copper and 47.2% chelators. A mixture of copper and chelator(s) may be useful for algae prevention and/or algae elimination. For example, 4.5 ounces of a mixture of copper and chelator(s) may be a good option for algae prevention, whereas 6 ounces of a mixture of copper and chelator(s) may be a good option for eliminating existing algae.

The solid ingredient may be in powder or granular form. Preferably, the solid ingredient is in powder form comprising (or consisting essentially of) particles having a particle size in a range of 50 to 2,000 microns. The solid ingredient may have an average particle size (or even a minimum particle size) of 50 to 2,000 microns. For example, aluminum sulfate and/or lanthanum chloride may have a minimum particle size and/or average particle size of 50 to 2,000 microns.

The water-deformable dispenser is retained in a water circulation system of a swimming pool. The water-deformable dispenser may include a water porous fabric to allow water to flow into and out of the water-deformable dispenser when the water-deformable dispenser is retained in the water circulation system (e.g., retained in a basket or housing thereof). The pore size of the water porous fabric may vary. For example, the water porous fabric can optionally have a pore size in a range of from 1 micron to 200 microns, such as from 1 micron to 150 microns (e.g., 5 to 50 microns). The water porous fabric may comprise one or more types of fabric configured to facilitate the flow of water. For example, the water porous fabric may comprise a polypropylene fabric, polyester fabric, mesh fabric, woven fabric, nonwoven fabric, natural fibers, microporous fabric, skived fabric, or combinations thereof. In one or more embodiments, the water porous fabric comprises polypropylene non-woven fabric. In one or more embodiments, the water porous fabric has a pore size in a range from 5 to 50 microns. Some examples involve polypropylene or polyester (optionally in non-woven form) having pore size in the range of from 5 to 50 microns.

In one or more embodiments, it may be desirable to provide an advantageous dissolution rate for the solid ingredient initially contained in the water-deformable dispenser. In some embodiments, the method comprises dissolving the solid ingredient initially contained in the water-deformable dispenser in a time ranging from 15 minutes to 2 hours, such as from 20 minutes to 2 hours. A dissolution time in one or both of these ranges can optionally be provided in any method embodiment of the present disclosure.

In one or more embodiments, the water-deformable dispenser is a packet or sachet such that the solid ingredient is retained within the packet or sachet. The size and shape of the water-deformable dispenser may be different in different embodiments, e.g., depending on various factors such as where the water-deformable dispenser is positioned within the water circulation system, pool size, etc. For example, the water-deformable dispenser preferably is retained in a skimmer basket, pump basket, or leaf catcher basket of the water circulation system. In one or more embodiments, the water-deformable dispenser has a rectangular shape.

Also within the scope of this disclosure is a method of preventing or eliminating growth of algae in a swimming pool using a water-deformable dispenser. In one or more embodiments, the method comprises flowing water into (and preferably through) and out of the flexible fabric packet, such that the water contacts the all-solid ingredient and dissolves the ingredient in the water to provide the flow of the ingredient out of the flexible fabric packet in a dissolved condition. This can advantageously provide that the ingredient is in the dissolved condition before reaching the body of water 10a of the swimming pool. In one or more embodiments, a clarifier or flocculant is provided in a dissolved condition to the body of water of the swimming pool and removes phosphate from the body of water of the swimming pool. In some cases, the flowing water into and out of the flexible fabric packet is performed for a time period in a range of from 15 minutes to 2 hours (or from 20 minutes to 2 hours), such that the all-solid ingredient (e.g., a clarifier or flocculant) is being dissolved throughout the time period.

A water-deformable dispenser having a coating that is dissolvable in water is also described herein. The coating may include poly vinyl alcohol (PVA), hydroxypropyl methylcellulose (HPMC), pullulan, gellan gum, sodium alginate, starch and modified starch, chitosan, carboxymethyl cellulose (CMC), pectin, gelatin, and combinations thereof.

In one or more embodiments, a method of preventing or eliminating growth of algae in a swimming pool that comprises a body of water and a water circulation system comprises retaining a water-deformable dispenser in the water circulation system (e.g., in a basket or housing thereof, such as in a skimmer basket) and dissolving a coating on the water-deformable dispenser in water in the water circulation system.

Thus, in one or more embodiments, the method comprises retaining a water-deformable dispenser in the water circulation system. The water-deformable dispenser may include an all-solid composition, a flexible fabric packet, and a coating on the water-deformable dispenser that is dissolvable in water. The flexible fabric packet may have pores sized to permit ingress and egress of water and to permit flow of the all-solid composition out of the flexible fabric packet in a dissolved condition. If desired, the pore opening size of the fabric may be in any range noted above. Additionally or alternatively, the all-solid composition may comprise powder having any particle size range noted above. The method may further include dissolving the coating in water in the water circulation system and dissolving the all-solid composition in water flowing into and out of the flexible fabric packet such that the all-solid composition flows out of the flexible fabric in the dissolved condition, thereby providing that the all-solid composition is in the dissolved condition before reaching the body of water 10a of the swimming pool.

In one or more embodiments, the coating retains the all-solid composition in the water-deformable dispenser prior to placing the water-deformable dispenser in water. Additionally or alternatively, the coating retains the all-solid composition in the water-deformable dispenser during shipping and handling of the water-deformable dispenser.

### Test Results

To test the effectiveness of a deformable water-mateable dispenser, a set of 5 in×5 in fabric packets were made from Polypoint 200HEM, Spun, Spunbound Pointbond Polyester, 15-Micron rating (supplied by Hanes Engineered Materials of Sharonville Ohio)

The contents of the field-tested water-mateable packets were as follows:
Copper Sulfate Pentahydrate (50% by weight)
Zinc Sulfate (clarifier 10% by weight)
Ethyelenediaminetetraccetic acid (chelant 10% by weight)
Triethanolamine (chelant 10% by weight)
Citric Acid (chelant 10% by weight)
Sodium Gluconate (chelant 10% by weight)

For 15,000-gallon pools, the water-mateable packet size was 5 in×5 in when empty and 4 in×4 in×1 in when filled with the above contents.

For 15,000-gallon pools, the water-mateable packet size was 5 in×7.5 in when empty and 3.5 in×6 in×1.5 in when filled with the above contents.

The packets were placed in the pool pump basket of 750 different pools up to 25,000 gallons. No algae outbreaks or staining were reported during a 6-month test period.

1. A water-deformable dispenser for retention in a water circulation system of a swimming pool, the water-deformable dispenser comprising:
a water porous fabric to allow water to flow into and out of the water-deformable dispenser when the water-deformable dispenser is retained in the water circulation system; and
a solid ingredient contained in the water-deformable dispenser, wherein the solid ingredient is a clarifier or flocculant when the solid ingredient is dissolved in water that flows out of the water-deformable dispenser and flows into a body of water of the swimming pool.

2. The water-deformable dispenser of claim 1, wherein the solid ingredient, when dissolved in water that flows out of the water-deformable dispenser and flows into the body of water of the swimming pool, is configured to remove phosphate from the body of water of the swimming pool.

3. The water-deformable dispenser of claim 1, wherein the solid ingredient comprises aluminum sulfate.

4. The water-deformable dispenser of claim 3, wherein the aluminum sulfate has a minimum particle size of 50 to 2,000 microns.

5. The water-deformable dispenser of claim 1, wherein the solid ingredient comprises lanthanum chloride.

6. The water-deformable dispenser of claim 5, wherein the lanthanum chloride has a minimum particle size of 50 to 2,000 microns.

7. The water-deformable dispenser of claim 1, wherein the water porous fabric has a pore size in a range of from 1 micron to 200 microns.

8. The water-deformable dispenser of claim 1, wherein the water porous fabric has a pore size in a range of from 5 to 50 microns.

9. The water-deformable dispenser of claim 1, wherein the water porous fabric comprises polypropylene fabric.

10. The water-deformable dispenser of claim 1, wherein the water porous fabric comprises polypropylene non-woven fabric.

11. The water-deformable dispenser of claim 1, wherein the solid ingredient comprises both aluminum sulfate and lanthanum chloride.

12. The water-deformable dispenser of claim 11, wherein the solid ingredient comprises a greater amount of lanthanum chloride than aluminum sulfate.

13. The water-deformable dispenser of claim 1, wherein the solid ingredient is in powder form.

14. The water-deformable dispenser of claim 1, wherein the solid ingredient is in powder form characterized by an average particle size in a range of 50 to 2,000 microns.

15. The water-deformable dispenser of claim 1, wherein the dispenser is devoid of a copper-containing algaecide.

16. The water-deformable dispenser of claim 1, wherein the solid ingredient consists of lanthanum chloride, aluminum sulfate, or both.

17. The water-deformable dispenser of claim 1, wherein the dispenser comprises a sachet having a rectangular shape.

18. A method of preventing or eliminating growth of algae in a swimming pool that comprises a body of water and a water circulation system, the method comprising:
retaining a water-deformable dispenser in the water circulation system, the water-deformable dispenser comprising a flexible fabric packet and an all-solid clarifier or flocculant, the flexible fabric packet having pores sized to permit ingress and egress of water and to permit a flow of the clarifier or flocculant out of the flexible fabric packet in a dissolved condition; and
flowing water into and out of the flexible fabric packet, such that the water contacts the clarifier or flocculant and dissolves the clarifier or flocculant in the water to provide the flow of the clarifier or flocculant out of the flexible fabric packet in the dissolved condition, thereby providing that the clarifier or flocculant is in the dissolved condition before reaching the body of water of the swimming pool.

19. The method of claim 18, wherein the clarifier or flocculant comprises aluminum sulfate, lanthanum chloride, or both.

20. The water-deformable dispenser of claim 19, wherein an amount of lanthanum chloride in the water-deformable dispenser is in a range from 3 to 8 ounces per 10,000 gallons of water in the body of water of the swimming pool.

21. The water-deformable dispenser of claim 19, wherein an amount of aluminum sulfate in the water-deformable dispenser is in a range from 5 to 10 ounces per 10,000 gallons of water in the body of water of the swimming pool.

22. The method of claim 18, wherein said flowing water into and out of the flexible fabric packet is performed for a time period in a range of from 15 minutes to 2 hours, such that the all-solid clarifier or flocculant is being dissolved throughout the time period.

23. The method of claim 18, wherein the solid ingredient comprises both aluminum sulfate and lanthanum chloride.

24. The method of claim 23, wherein the solid ingredient comprises a greater amount of lanthanum chloride than aluminum sulfate.

25. The method of claim 18, wherein the clarifier or flocculant in the dissolved condition reaches the body of water of the swimming pool and removes phosphate from the body of water of the swimming pool.

26. The method of claim 18, wherein the water-deformable dispenser is retained in a skimmer basket, pump basket, or leaf catcher basket of the water circulation system.

27. The method of claim 18, wherein the water-deformable dispenser is devoid of a copper-containing algaecide.

28. The method of claim 18, wherein the solid ingredient consists of lanthanum chloride, aluminum sulfate, or both.

29. A water-deformable dispenser for retention in a water circulation system of a swimming pool, the water-deformable dispenser comprising:
a water porous fabric to allow water to flow into and out of the water-deformable dispenser when the water-deformable dispenser is retained in the water circulation system of the swimming pool;
a solid ingredient contained in the water-deformable dispenser, the solid ingredient being in a powder form that is dissolvable in water; and
a coating on the water-deformable dispenser that is dissolvable in water.

30. The water-deformable dispenser of claim 29, wherein the coating comprises a Poly Vinyl Alcohol (PVA) material.

31. The water-deformable dispenser of claim 29, wherein the solid ingredient comprises a phosphate removal agent.

32. The water-deformable dispenser of claim 31, wherein the phosphate removal agent comprises aluminum sulfate, lanthanum chloride, or both.

33. The water-deformable dispenser of claim 32, wherein the water porous fabric has a pore size in a range of from 5 to 50 microns.

34. The water-deformable dispenser of claim 33, wherein the phosphate removal agent has a minimum particle size of 50 to 2,000 microns.

35. The water-deformable dispenser of claim 29, wherein the water-deformable dispenser is devoid of a copper-containing algaecide.

36. A method of preventing or eliminating growth of algae in a swimming pool that comprises a body of water and a water circulation system, the method comprising:
retaining a water-deformable dispenser in the water circulation system, the water-deformable dispenser comprising:
an all-solid composition;
a flexible fabric packet, the flexible fabric packet having pores sized to permit ingress and egress of water and to permit flow of the all-solid composition out of the flexible fabric packet in a dissolved condition; and
a coating on the water-deformable dispenser that is dissolvable in water;
dissolving the coating in water in the water circulation system; and
dissolving the all-solid composition in water flowing into and out of the flexible fabric packet such that the all-solid composition flows out of the flexible fabric in the dissolved condition, thereby providing that the all-solid composition is in the dissolved condition before reaching the body of water of the swimming pool.

37. The water-deformable dispenser of claim 36, wherein the coating retains the all-solid composition in the water-deformable dispenser prior to placing the water-deformable dispenser in water.

38. The water-deformable dispenser of claim 36, wherein the coating retains the all-solid composition in the water-deformable dispenser during shipping and handling of the water-deformable dispenser.

39. The method of claim 36, wherein the water-deformable dispenser is retained in a skimmer basket, pump basket, or leaf catcher basket of the water circulation system.
